(19) United States
(12) Patent Application Publication
(10) Pub. No.: US 2017/0232411 A1
(43) Pub. Date: Aug. 17, 2017

(54) Determining the Consistency of a Mixture

(71) Applicant: Intelligent Automation Design, LLC, Yardley, PA (US)

(72) Inventors: Mark Smith, Yardley, PA (US); Joseph Whyte, Branchburg, NJ (US)

(73) Assignee: Intelligent Automation Design, LLC, Yardley, PA (US)

(21) Appl. No.: 15/521,769

(22) PCT Filed: Nov. 3, 2015
(86) PCT No.: PCT/US2015/058858

§ 371 Date: Apr. 25, 2017

Related U.S. Application Data
(60) Provisional application No. 62/074,184, filed on Nov. 3, 2014.

(51) Int. Cl. B01F 15/00; B01F 7/22

(52) U.S. Cl. CPC B01F 15/00285; B01F 15/00201; B01F 15/00214; B01F 7/22; B01F 2215/007

(57) ABSTRACT

Determining the consistency of a mixture during a mixing process based on feedback from the mixer. The feedback may be indicative of the torque exerted on a motor shaft of the mixer. The consistency of the mixture may be determined based on the amount of torque, rate of change of torque, change in the rate of change of torque and/or a comparison of the torque information to a stored torque profile. The torque may be determined based on the current in the coils of a motor of the mixer (e.g., by measuring the voltage across a precision resistor in series with the coils). Alternatively, the feedback may be indicative of the angular velocity of the motor shaft, sound output by the mixer, vibration of the mixer, color of the mixture, or opacity of the mixture.

### CROSS REFERENCE TO RELATED APPLICATIONS

This application claims priority to U.S. Prov. Pat. Appl. No. 62/074,184, filed Nov. 3, 2014, the entire contents of which are hereby incorporated by reference.

### BACKGROUND

Field of the Invention

The present disclosure is directed to mixing multiple ingredients to form a mixture, more specifically to determining whether the mixture has achieved a desired consistency based on feedback received during the mixing process.

Description of Related Art

Mixing is the process of combining different ingredients to produce a target mixture. While there are many types of mixing processes, all mixing processes can generally be categorized as either batch mixing or continuous mixing. In a batch mixing operation, all ingredients are loaded into a mixer together (or in a pre-defined sequence) and mixed until a homogenous product is produced and discharged from the mixer in a single lot. In a continuous mixing operation, ingredients are continuously loaded into a charging port of a mixer according to a formulation, the ingredients are mixed as they travel from the charging port to a discharge nozzle, and the combined mixture is discharged from the discharge nozzle.

To determine whether a mixture has achieved a desired consistency, the mixture (or a portion of the mixture) may be tested. For example, a viscometer may be used to determine whether a portion of the mixture has achieved a target viscosity. In another example, a rheometer may be used to determine how a portion of the mixture flows in response to applied forces. In a simpler example, a person making a frozen margarita may stir or touch or taste the margarita to see if the ice has been sufficiently blended.

In many instances, it is desirable to automate a mixing process. For example, automating an industrial mixing process may increase the uniformity of an industrial product and reduce cost. In another example, automating a frozen cocktail process may allow a bartender to perform other tasks while a blender prepares the drink.

A mixing process may be automated by mixing the same ingredients for the same time period. The consistency of each mixture may not be uniform, however, because of inconsistency in the ingredients, changes to the mixing apparatus over time, changes in atmospheric conditions, etc.

In order to produce mixtures with the desired consistency, it is desirable to determine the consistency of a mixture. If the consistency of the mixture can be determined during the mixing process, a determination can be made that the mixing process (or a phase in a multi-part mixing process) is complete. If the consistency of the mixture can be determined without the need to test the mixture (or a portion of the mixture), then the decision that the mixing process is complete can be automated.

Accordingly, there is a need to determine the consistency of a mixture during a mixing process without testing the mixture (or a portion of the mixture).

In a separate field of endeavor, U.S. Pat. No. 7,091,683 teaches a method of controlling a motor used to drive a screwdriver bit such that screws are seated to the optimum point of grip between the screw and the work piece material independent of the material density.

### SUMMARY

According to an exemplary embodiment of the present invention, there is provided a mixer, including an impeller that agitates the ingredients to form the mixture, a motor shaft that rotates the impeller, a motor that exerts torque on the motor shaft to rotate the motor shaft, a feedback device that outputs feedback, and a controller that determines a consistency of the mixture based on the feedback.

According to another exemplary embodiment of the present invention, there is provided a method of mixing ingredients to form a mixture by exerting torque on a motor shaft to rotate the motor shaft and an impeller, outputting feedback to a controller, and determining a consistency of the mixture based on the feedback.

The feedback may be indicative of the torque exerted on the motor shaft. The consistency of the mixture may be determined based on the amount of torque (or rate of change of torque or change in the rate of change of torque) required to rotate the motor shaft at an angular velocity. The controller may determine whether the mixture has achieved a desired consistency by comparing the torque information to a stored torque profile indicative of the relationship between the angular velocity of the motor shaft and the torque required to rotate the motor shaft at the angular velocity. The torque information may be determined based on the current in the coils of the motor (e.g., by measuring the voltage across a precision resistor in series with the coils of the motor).

Alternatively, the feedback may be indicative of the angular velocity of the motor shaft, sound output by the mixer, vibration of the mixer, a color of the mixture, or opacity of the mixture.

### BRIEF DESCRIPTION OF THE DRAWINGS

Preferred embodiments of the present invention will be set forth with reference to the drawings, in which:

FIG. 1 illustrates a related art mixer;

FIG. 2 illustrates a mixer according to an exemplary embodiment of the present invention;

FIG. 3 illustrates a torque profile according to an exemplary embodiment of the present invention; and

FIG. 4A is a flowchart illustrating a method of mixing according to an exemplary embodiment of the present invention;

FIG. 4B is a flowchart illustrating a method of mixing according to another exemplary embodiment of the present invention.

### DETAILED DESCRIPTION OF THE PREFERRED EMBODIMENTS

Preferred embodiments will be set forth in detail with reference to the drawings, in which like reference numerals refer to like elements or steps throughout.

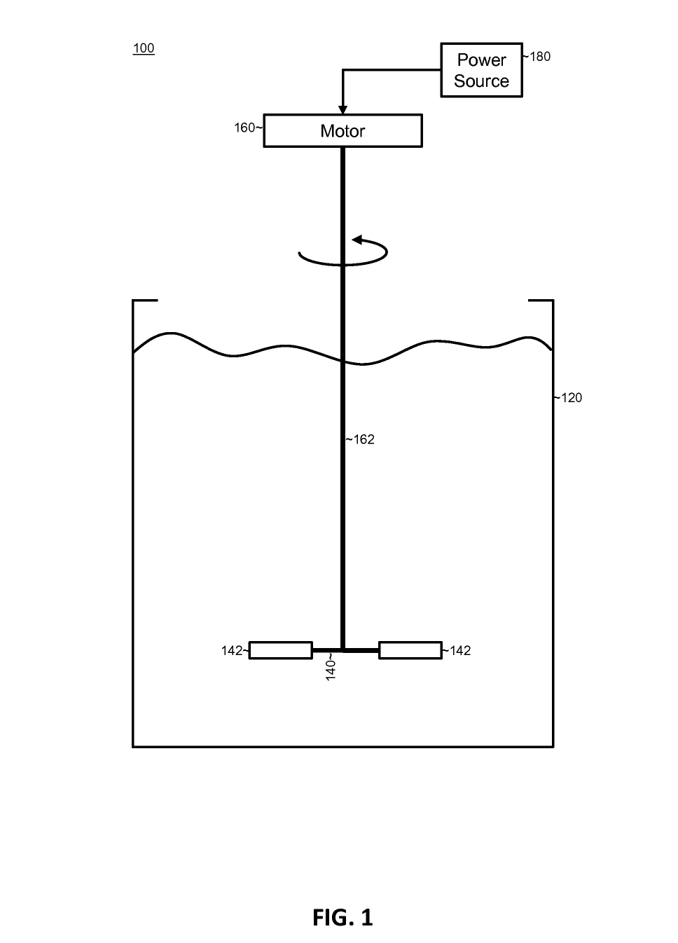

FIG. 1 illustrates a related art mixer 100. The mixer 100 includes a mixing container 120, an impeller 140, a motor 160, a motor shaft 162, and a power source 180. The mixing container 120 (partially or fully) stores the ingredients, the impeller 140, and the resulting mixture. The power source 180 supplies power to the motor 160, which rotates the motor shaft 162 and the impeller 140. The impeller 140 may be any device that transfers energy from the motor 160 to the ingredients to agitate the ingredients. The impeller 140 may include blades 142 that may make any angle with respect to the plane of rotation of impeller 140. The impeller 140 may be connected the motor shaft 162 using any mechanical connection devices such as couplings, gearboxes, and drive shafts, etc.

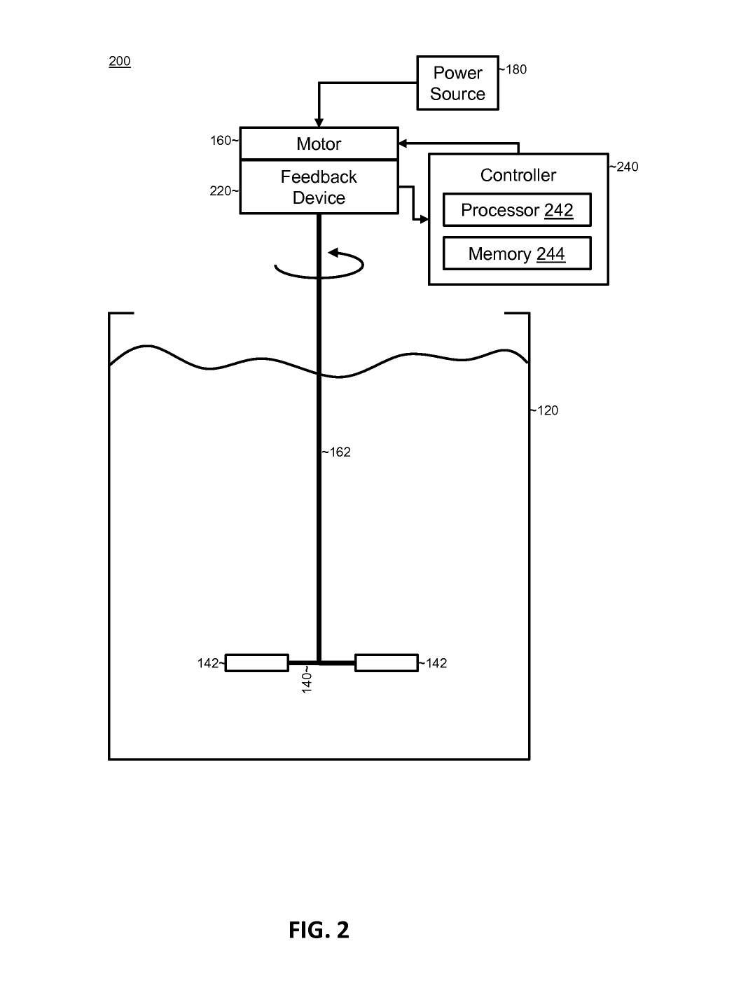

FIG. 2 illustrates a mixer 200 according to an exemplary embodiment of the present invention. The mixer 200 includes a feedback device 220 and a controller 240. The controller includes a processor 242 and memory 244. Similar to the related art mixer 100, the mixer 200 includes a mixing container 120, an impeller 140 (that may include blades 142), a motor 160, a motor shaft 162, and a power source 180.

As shown in FIG. 2, the feedback device 220 outputs feedback regarding the mixing process to the controller 240. The processor 242 of the controller 240 determines the consistency of the mixture basted on the feedback received from the feedback device 220.

In one embodiment, the mixer 200 may determine the consistency of the mixture during the mixing process based on the relationship between the angular velocity of the motor shaft 162 and the torque required to rotate the motor shaft 162. The relationship between the torque required to rotate the motor shaft 162 and the angular velocity of the motor shaft is referred to as a “torque profile” (or “torque fingerprint”).

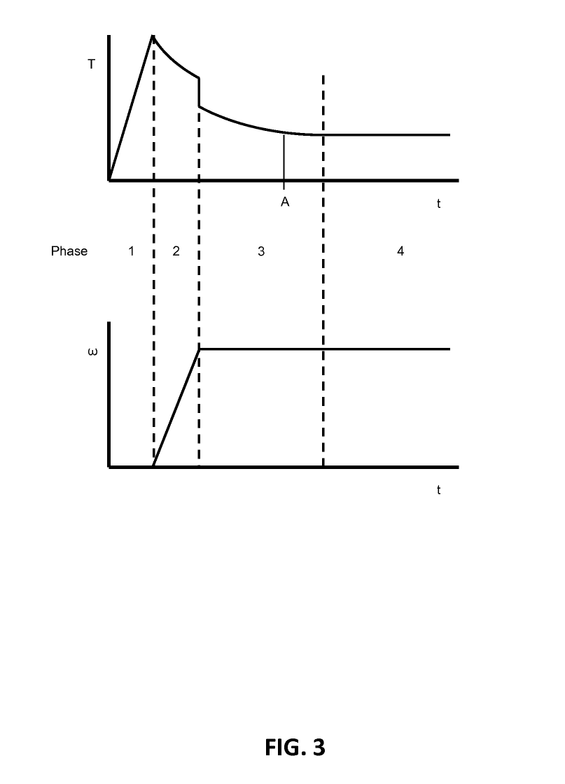

FIG. 3 illustrates a torque profile according to an exemplary embodiment of the present invention. The torque profile shows the angular velocity ω of the motor shaft 162 over time and the corresponding torque τ exerted on the motor shaft 162 by the motor 160 to rotate the motor shaft 162 at the angular velocity ω over the same time period.

As illustrated in FIG. 3, the mixing process may be divided into phases: In phase 1, the torque τ exerted on the motor shaft 162 by the motor 160 ramps up until the motor shaft 162 begins to rotate. In phase 1, the angular velocity ω of the motor shaft 162 is zero. In phase 2, the angular velocity ω of the motor shaft 162 increases as the motor shaft 162 accelerates and the torque τ required to accelerate the motor shaft 162 decreases as the mixture becomes more homogenous. In phase 3, the angular velocity ω of the motor shaft 162 is constant and the torque τ required to rotate the motor shaft 162 at the constant the angular velocity ω decreases as the mixture continues to become more homogenous. Between phase 2 and phase 3, the torque τ exerted on the motor shaft 162 by the motor 160 decreases as the motor 160 is no longer accelerating the motor shaft 162. In phases 3 and 4, the angular velocity ω of the motor shaft 162 is kept constant. In phase 4, the mixture is completely homogenous and both the angular velocity ω of the motor shaft 162 and the torque τ required to maintain the angular velocity ω of the motor shaft 162 are constant.

Each time the mixer 200 is used to mix the same ingredients, the relationship between the angular velocity ω and the torque τ follows a similar pattern (such as the pattern illustrated in FIG. 3). The relationship between the angular velocity ω and the torque τ is based on the consistency of the mixture over the course of the mixing process.

Accordingly, the mixer 200 may determine the consistency of the mixture based on the relationship between the angular velocity of the motor shaft 162 and the torque required to achieve the angular velocity ω of the motor shaft 162. In one embodiment, the mixer 200 may determine the consistency of the mixture based on the amount of torque required to achieve the angular velocity ω of the motor shaft 162. In another embodiment, the mixer 200 may determine the consistency of the mixture based on the rate of change of torque. In another embodiment, the mixer 200 may determine the consistency of the mixture based on a change in the rate of change of torque (for example, if the mixer 200 transitions from requiring an increasing amount of torque to maintain an angular velocity ω of the motor shaft 162 to requiring a constant amount of torque to maintain the angular velocity ω of the motor shaft 162, or if the mixer 200 transitions from requiring a constant amount of torque to maintain an angular velocity ω of the motor shaft 162 to requiring a decreasing amount of torque to maintain the angular velocity ω of the motor shaft 162, etc.)

In another embodiment, the mixer 200 may determine whether the mixture has achieved the target consistency as the mixing process follows the torque profile. As illustrated in FIG. 3, for example, the mixture may achieve the target consistency when the relationship between the angular velocity and the torque is consistent with point A. Accordingly, the controller 240 may determine that the mixture has reached the target consistency when the mixing process reaches point A.

Referring back to FIG. 2, the controller 240 outputs instructions to the motor 160 to rotate the motor shaft 162 at a given angular velocity. The motor 160 outputs torque to achieve the given angular velocity. Meanwhile, the feedback device 220 outputs information indicative of the torque to the controller 240. The controller 240 compares the relationship between the angular velocity and the torque to a torque profile stored in the memory 244.

If the motor 160 is an electrical motor, the torque exerted on the motor shaft 162 by the motor 160 is proportional to the amount of electrical current flowing through the coils of the motor 160. The electrical current may be measured as voltage produced across a resister that is in series with the coils of the motor 160 as described in U.S. Pat. No. 7,091,683. Accordingly, in one embodiment, the motor 160 may include a precision resistor in series with the motor coils and the feedback device 220 by determining the torque exerted on the motor shaft 162 by the motor 160 based on the voltage across the precision resistor.

While the torque output by the motor will generally follow the torque profile, the amount of torque will also have peaks and/or valleys (for example, if the impeller 160 makes contact with solids in the mixture). Accordingly, the mixer 200 may include a smoothing circuit that averages the voltage across the precision resistor over time so as to remove the peaks and/or valleys from the torque signal. For example, the feedback device 220 may include an analog smoothing circuit (e.g., a capacitor with resistors and/or a diode). Additionally or alternatively, the controller 240 may digitally smooth the analog signal output by the feedback device 220.

The feedback device 220 may also output information indicative of the angular velocity of the motor shaft 162 to the controller 240. In order to determine the angular velocity, the feedback device 220 may include an encoder, a Hall Effect sensor, a back EMF sensor, etc.

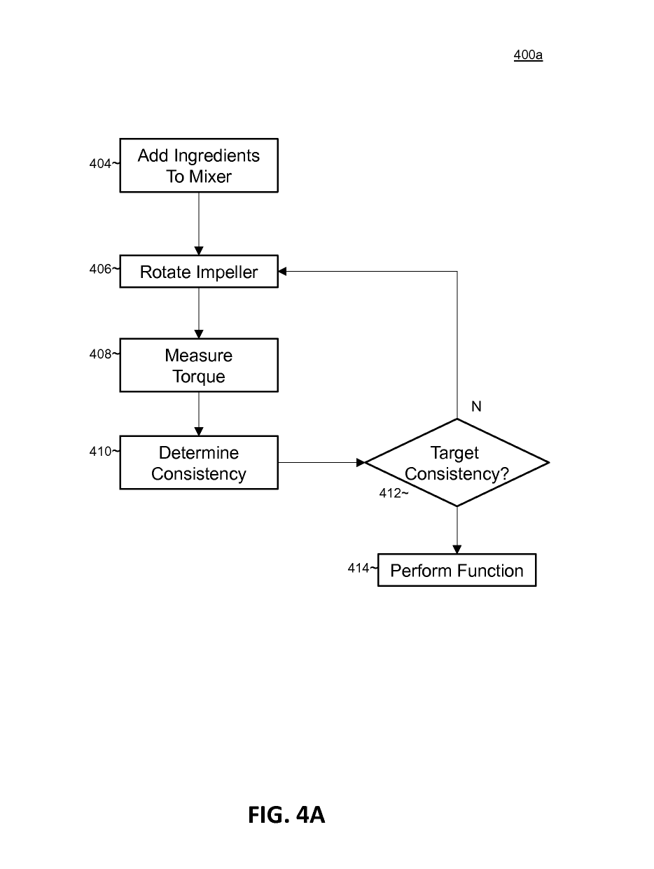

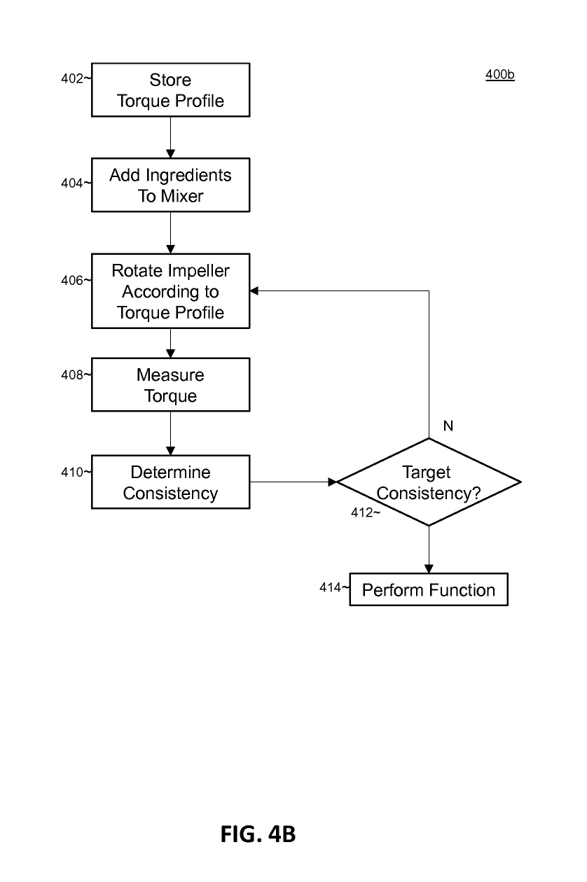

FIG. 4A is a flowchart illustrating a mixing process 400a performed by the mixer 200 according to an exemplary embodiment of the present invention.

Ingredients are added to the mixer 200 in step 404. The motor 160 rotates the impeller 140 in step 406. The motor 160 may rotate the impeller 140 at a known, constant angular velocity or following a known pattern. The feedback device 220 measures the torque and outputs information indicative of the torque measurement in step 408. The controller 240 determines the consistency of the mixture in step 410. As described above, the controller 240 may determine the consistency of the mixture based on the amount of torque, the rate of change of torque, etc. In step 412, the controller 240 determines whether the mixture has achieved a target consistency. If the mixture has yet to achieve the target consistency (step 412: No), the process returns to step 406 and the mixer continues to rotate the impeller 140 and mix the ingredients.

If the controller 240 determines that the mixture has achieved the target consistency, the mixer 240 performs a function in step 414. In one example, the controller 240 may stop the mixing process in step 414. In another example, the mixer 200 may output an indication to another system or a human operator that the mixture has achieved the target consistency in step 414. In another example, the mixer 200 may be configured to add an additional ingredient to the mixing container 120 in step 414 (or output an indication to another system or a human operator to add an additional ingredient to the mixing container 120). The additional ingredient may be a new ingredient or an additional quantity of an ingredient that has already been mixed. In a continuous mixing process, for example, additional solvent may be added if the controller 240 determines based on the torque that a portion of the solvent in the mixture has evaporated. In another example, the controller 240 may change the torque output by the motor 160, the rate of change of the torque output by the motor 160, the angular velocity of the motor shaft 162, the rate of change of the angular velocity of the motor shaft 162, etc.

FIG. 4B is a flowchart illustrating a mixing process 400b performed by the mixer 200 according to an exemplary embodiment of the present invention.

The mixing process 400b includes many of the same steps as the mixing process 400b. The mixing process 400b includes the additional step of storing a torque profile in step 402. In step 406, the motor 160 rotates the impeller 140 at the angular velocity indicated in the torque profile. In steps 410 and 412, the controller 240 determines whether the mixture has achieved a target consistency based on a comparison of the torque information received from the feedback device 220 and the torque profile.

The mixer 200 may be used to create the torque profile. For example, a user may mix ingredients in the mixer 200. The feedback device 200 may output torque information and angular velocity information to the controller 240 as described above. The mixer 200 may allow the user to indicate when the mixture has achieved the desired consistency. The controller 240 may store a torque profile in the memory 244. The torque profile may include the torque information received from the feedback device 220, the angular velocity information received from the feedback device 220, and the point at which the mixture achieved the desired consistency.

The torque profile illustrated in FIG. 3 is just one example of a torque profile.

First, the relationship between the torque and the angular velocity will differ based on the ingredients (for example, the torque required to maintain a constant angular velocity may increase due to evaporation of solvents).

Second, the mixer 200 may be configured such that the angular velocity ω of the motor shaft 162 exhibits any desired pattern. As long as the motor shaft follows the same angular velocity ω pattern as stored in the torque profile, the controller 160 may determine the consistency of the mixture based on the torque τ.

Third, the controller 240 may not store a torque profile that encompasses all phases of the mixing process. For example, the torque profile stored in memory 244 may only illustrate the relationship between the torque τ and a constant angular velocity ω as shown in phase 3. In that example, the mixer 200 first accelerates the motor shaft 162 to a constant angular velocity ω before determining the consistency of the mixture based on the torque τ.

As described above, the relationship between the torque τ output by the motor 160 and the angular velocity ω of the motor shaft 162 depends on the consistency of the mixture. Accordingly, as one of ordinary skill in the art will recognize, the mixer 200 may be configured such that the motor 160 outputs torque τ following a known pattern and determines the consistency of the mixture based on the resulting angular velocity ω of the motor shaft 162, a rate of change of the angular velocity ω, a change in the rate of change of the angular velocity ω, and/or comparison between the angular velocity and an angular velocity profile (similar to the torque profile illustrated in FIG. 3 and described above).

Using the same principles discussed above, the mixer 200 may determine the consistency of the mixture based on other types of feedback. For example, the sound and/or vibration output by the mixer 200 may follow a consistent pattern during the mixing process. Accordingly, feedback device 220 may measure the sound output by the mixer 200 (for example, using a microphone) or determine the vibration of the mixer 200 (for example, using an accelerometer or other vibration sensor) and output information indicative of the sound/vibration to the controller 240, which may determine whether the mixture has achieved the target consistency based on the sound/vibration information. In one example, the controller 240 may determine the consistency of the mixture based on the amount of sound/vibration. Additionally or alternatively, the controller 240 may determine the consistency of the mixture based on the rate of change of the sound/vibration. Additionally or alternatively, the controller 240 may determine the consistency of the mixture based on a change in the rate of change of the sound/vibration. Additionally or alternatively, the controller 240 may store a sound and/or vibration profile (similar to the torque profile illustrated in FIG. 3) in the memory 244 and the controller 240 may determine whether the mixture has achieved the target consistency by comparing the sound/vibration information received from the feedback device 220 to the sound/vibration profile.

To cite just one example of a mixer 200 that may use sound or vibration to control a mixing process, a garbage disposal that mixes solids with water and grounds the mixture may automatically shut off when the sound or vibration output by the garbage disposal indicates that the solids have been disposed of.

In another embodiment, the consistency of the mixture may be determined based on the behavior of light as it passes through and/or reflects off of the mixture. In this embodiment, the feedback device 220 may include an optical emitter that emits light through and/or off the mixture and an optical sensor that receives the light after. The optical sensor may output information indicative of the light to the controller 240, which may determine the consistency of the mixture based on the signal output by the optical sensor. For example, the controller 240 may determine the consistency of the mixture based on the opacity and/or color of the mixture. Additionally or alternatively, the controller 240 may determine the consistency of the mixture based on a change in the opacity and/or color of the mixture. Additionally or alternatively, the controller 240 may store a light profile (similar to the torque profile illustrated in FIG. 3) and determine the consistency of the mixture by comparing the signal received from the feedback device 220 to the light profile.

Determining the consistency of the mixture based on feedback (e.g., torque, velocity, sound, vibration, light, etc.) received during the mixing process provides a number of benefits. First, the consistency of the mixture can be accurately controlled to produce repeatable results. Additionally, the mixing process may be automated to reduce cost. Finally, because the mixing process may stop when the mixture has achieved the desired consistency, efficiency may be increased while processing time, cost, and wear and tear on the mixer 200 may be reduced.

The mixer 200 may be any device configured to agitate any number of ingredients, such as a ribbon blender, a paddle blender, vertical screw blender, a sigma mixer, a planetary mixer, a plow mixer, a double paddle mixer, a Forberg mixer, etc.

The mixer 200 may be configured to allow a user to select a desired consistency (for example, via an operator panel, a wireless connection to a smartphone or personal computer, and/or another input device). The mixer 200 may also be configured to determine and store the consistency of a mixture in the memory 224 and to use the stored consistency as the target consistency during a subsequent mixing process.

The impeller 140 may be an axial flow impeller with blades 142 that make an angle of less than 90 degrees from the plane of impeller rotation (e.g., marine propellers, pitched blade turbines, etc.), a radial flow impeller with blades 142 that are parallel to the axis of the impeller 140 (e.g., flat blade turbines, paddles, etc.), etc.

The mixing process may be industrial, commercial, personal, etc. The term “mixing” may to refer to any process of combining any number of ingredients. In one embodiment, the ingredients being mixed may be different. In another embodiment, chemically homogenous material may be mixed to produce a uniform lot with consistent particle size distribution, color, texture, and/or other attributes. The ingredients may in be any fundamental state (i.e., solid, liquid, gas, plasma), may be a combination of multiple fundamental states, and/or may transition from one fundamental state to another during the mixing process.

The terms “mixing” and “blending” are often used interchangeably, but are sometimes used to describe different processes. Blending may be used to describe solid-solid mixing or mixing of bulk solids with a small quantity of liquid, while mixing may be used to describe liquid-liquid mixing, gas-liquid mixing, and viscous material mixing. The term “mixing” is used throughout this application to refer to both mixing and blending.

As used herein, the consistency of a mixture may refer to any characteristic of the mixture that affects the way the mixture holds together such as thickness, density, viscosity, heaviness, texture, firmness, solidity, evenness, uniformity, regularity, stability, equilibrium, etc.

In addition to the mixing processes described above, similar feedback may be used in conjunction with other pumping processes. For example, a gas supply line may be monitored using a vibration sensor to detect the vibration caused when the gas is flowing through a supply line. The microprocessor can be programmed to distinguish between normal gas usage and a leak. The system can be integrated with sensors on devices that normally or periodically call for gas and learn which patterns are normal. If the gas flow is determined to be abnormal, indicating a leak, the microprocessor can close the gas valve automatically. Additionally an audible signal, wireless signal to a smart phone or PC could be produced. This can reduce the risk of fire or explosion on the premises.

In another example, toilet water supply can be monitored/controlled by placing a vibration sensor on the toilet to detect the vibration caused when the valve is open allowing water into the tank. If the water flows for greater than a programmed time period, the microprocessor can close a valve which supplies water to the tank. This would reduce water waste and the risk of flooding the premises. Additionally an audible signal or wireless signal to a smart phone could be produced.

In another example, water supply to a premises can be monitored and controlled by placing a vibration sensor on the water supply to detect the vibration caused when the water is flowing through a supply pipe. If the water flows for greater than a programmed time period, the microprocessor can close a valve that supplies water to the premises. This would reduce water waste and the risk of flooding the premises. Additionally an audible signal or wireless signal to a smart phone could be produced.

While preferred embodiments have been set forth in detail, it will be appreciated that other embodiments can be realized within the scope of the invention. The present invention should be construed as limited only by the appended claims.

What is claimed is:

1. A mixer that mixes ingredients to form a mixture, the mixer comprising:
an impeller that agitates the ingredients to form the mixture;
a motor shaft that rotates the impeller;
a motor that exerts torque on the motor shaft to rotate the motor shaft;
a feedback device that outputs feedback; and
a controller that determines a consistency of the mixture based on the feedback.

2. The mixer of claim 1, wherein the feedback is torque information indicative of the torque exerted on the motor shaft.

3. The mixer of claim 2, wherein the controller determines the consistency of the mixture based on any one of:
an amount of torque required to rotate the motor shaft at an angular velocity;
a rate of change of the amount of torque required to rotate the motor shaft at the angular velocity; or
a change in the rate of change of the amount of torque required to rotate the motor shaft at the angular velocity.

4. The mixer of claim 2, wherein the controller:
stores a torque profile that includes information indicative of a relationship between an angular velocity of the motor shaft and the torque required to rotate the motor shaft at the angular velocity; and
determines whether the mixture has achieved a desired consistency by comparing the torque profile and the torque information received from the feedback device.

5. The mixer of claim 4, wherein the controller outputs an instruction to the motor to rotate the motor shaft consistent with the angular velocity stored in the torque profile.

6. The mixer of claim 4, wherein:
the feedback device further outputs angular velocity information indicative of the angular velocity in the motor shaft; and
the controller determines whether the mixture has achieved the desired consistency by comparing the torque profile, the torque information received from the feedback device, and the angular velocity information received from the feedback device.

7. The mixer of claim 2, wherein the feedback device determines the torque information based on an amount of current in coils of the motor.

8. The mixer of claim 7, wherein the feedback device comprises a resistor in series with the coils of the motor and the feedback device:
determines the amount of current in the coils by measuring a voltage across the resistor; and
outputs a voltage signal indicative of the voltage across the resistor.

9. The mixer of claim 8, wherein the feedback device includes an averaging circuit that averages the voltage signal.

10. The mixer of claim 8, wherein the controller averages the voltage signal.

11. The mixer of claim 1, wherein the feedback is information indicative of any one of:
an angular velocity of the motor shaft;
sound output by the mixer;
vibration of the mixer;
a color of the mixture; or
opacity of the mixture.

12. A method of mixing ingredients to form a mixture, the method comprising:
exerting torque on a motor shaft, by a motor, to rotate the motor shaft;
rotating an impeller, by the motor shaft, to mix the ingredients and form the mixture;
outputting feedback to a controller; and
determining a consistency of the mixture, by the controller, based on the feedback.

13. The method of claim 12, wherein the feedback is torque information indicative of the torque exerted on the motor shaft.

14. The method of claim 13, wherein the controller determines the consistency of the mixture based on any one of:
an amount of torque required to rotate the motor shaft at an angular velocity;
a rate of change of the amount of torque required to rotate the motor shaft at the angular velocity; or
a change in the rate of change of the amount of torque required to rotate the motor shaft at the angular velocity.

15. The method of claim 13, further comprising:
storing a torque profile that includes information indicative of a relationship between an angular velocity of the motor shaft and the torque required to rotate the motor shaft at the angular velocity,
wherein the controller determines whether the mixture has achieved a desired consistency by comparing the torque profile and the torque information received from the feedback device.

16. The method of claim 13, wherein the torque information is determined based on an amount of current in coils of the motor.

17. The method of claim 16, wherein the amount of current in the coils of the motor is determined by:
measuring a voltage across a resistor in series with the coils; and
outputing a voltage signal indicative of the voltage across the resistor.

18. The method of claim 17, further comprising:
averaging the voltage signal using an averaging circuit.

19. The method of claim 17, further comprising:
averaging the voltage signal using the controller.

20. The method of claim 12, wherein the feedback is information indicative of any one of:
an angular velocity of the motor shaft;
sound output as the ingredients are mixed to form the mixture;
vibration as the ingredients are mixed to form the mixture;
a color of the mixture; or
opacity of the mixture.
